(19) United States
(12) Patent Application Publication
(10) Pub. No.: US 2023/0079459 A1
(43) Pub. Date: Mar. 16, 2023

(54) MOVABLE DIE CUTTER DEVICE

(71) Applicant: Cymtek Solutions, Inc., Tainan City (TW)

(72) Inventors: YI-SO WANG, Tainan City (TW); LUNG-HSING WU, Tainan City (TW)

(21) Appl. No.: 17/991,068

(22) Filed: Nov. 21, 2022

(30) Foreign Application Priority Data
Aug. 17, 2021 (TW) 111130961

(51) Int. Cl. B26D 7/26; B26F 1/38

(52) U.S. Cl. CPC B26D 7/2635; B26F 1/384

(57) ABSTRACT

A movable die cutter device of the invention cutting patterns on a continuous sheet comprises a set of die cutter cutting the continuous sheet, a movable platform, a skid rail device, at least one sensing device and a control device. The set of movable units is fixed between the base and the upper plate to control a movement of the upper plate. The movable platform comprises a base, a set of movable units, and un upper plate. The skid rail device comprises a sliding block unit fixing the set of die cutter and the upper plate of the movable platform. The skid rail unit is disposed on the base of the movable platform and the sliding block unit sliding thereon. The control device controls the set of movable units of the of movable platform. When the sensing device senses an offsets between the patterns and the set of die cutter, the control device controls the set of movable units of the movable platform to move so that the shift offset can be compensated.

### CROSS-REFERENCE TO RELATED APPLICATION

This application claims the priority benefit of Taiwan application no. 111130961, filed 2022 Aug. 17. The entirety of each of the above-mentioned patent applications is hereby incorporated by reference herein and made a part of this specification.

### TECHNICAL FIELD

The disclosure relates to a movable rotary die cutter device.

### BACKGROUND

Referring to FIG. 1, a traditional rotary die cutter device comprises a set of die cutter 100, 120, 140, 160 and 180. The set of die cutter 100 comprises a transmission shaft 101, a anvil roll 103, a cutter roll 105, and CCD (Charge Coupled Device) image sensing unit 107. When a continuous sheet pass through a set of die cutter 100, blade protrusion disposed on the cutter roll 105 cuts patterns on the continuous sheet sequentially. However, when the continuous sheet moves, there might be offset that prevent the die cutter cutting patterns precisely. The traditional means is to dispose a movable mechanism (not shown) beside the cutter roll 105 of the die cutters 100. When the image sensor unit detects a deviation of the shape, the movable mechanism will move accordingly to changes an angle between the set of die cutter and the continuous sheet, so that the patterns can be cut precisely. However, a structure of the traditional die cutter device is complex and the movable mechanism will cause the center of gravity of the cutter roll to shift and affect the average cutting force. The invention discloses a device can change an angle between a die cutter and a continuous sheet stably, so that a structure of the die cutter can be simplified.

### SUMMARY

Accordingly, the present disclosure provides a movable die cutter device for cutting a plurality of patterns on a continuous sheet. The movable die cutter device of the invention cutting patterns on a continuous sheet comprises a set of die cutter cutting the continuous sheet, a movable platform, a skid rail device, at least one sensing device and a control device. The set of movable units is fixed between the base and the upper plate to control a movement of the upper plate. The movable platform comprises a base, a set of movable units, and un upper plate. The skid rail device comprises a sliding block unit fixing the set of die cutter and the upper plate of the movable platform, and a skid rail unit is disposed on the base of the movable platform and the sliding block unit sliding thereon. The control device controls the set of movable units of the of movable platform. When the sensing device senses an offsets between the patterns and the set of die cutter, the control device controls the set of movable units of the movable platform to move so that the shift offset can be compensated

According to the movable die cutter device of the invention, the sliding block unit comprises a fixed rotation element and a slide. The fixed rotation element can fix the set of die cutter on the upper plate and can rotate relative to the sliding block. The skid rail unit comprises a skid rail and a skid rail seat for fixing the skid rail thereon, and the slide can slide on the skid rail.

According to the movable die cutter device of the invention, at least one of movable units is disposed on the first corner of the movable platform, at least one of movable units is disposed on the second corner of the movable platform, and at least one of movable units is disposed on the third corner of the movable platform.

According to the movable die cutter device of the invention, the set of movable units comprises at least one first direction mobile unit moving in a first direction horizontally, and at least one second direction mobile unit moving in a second direction horizontally which is perpendicular to the first direction. The at least one first direction mobile unit and the at least one second direction mobile unit separately control the die cutter moving in a first direction or in a second direction.

According to the movable die cutter device of the invention, the set of movable units can control the die cutter to rotate horizontally.

According to the movable die cutter device of the invention, a long axis of the skid rail device is substantially parallel to a long axis direction of the die cutter.

According to the movable die cutter device of the invention, the die cutter is disposed on the center of the upper plate.

According to the movable die cutter device of the invention, sensing devices are separately arranged on the upstream and downstream of the continuous sheet entering the die cutter.

### BRIEF DESCRIPTION OF THE DRAWINGS

FIG. 1 is a schematic view of a traditional die cutter device.

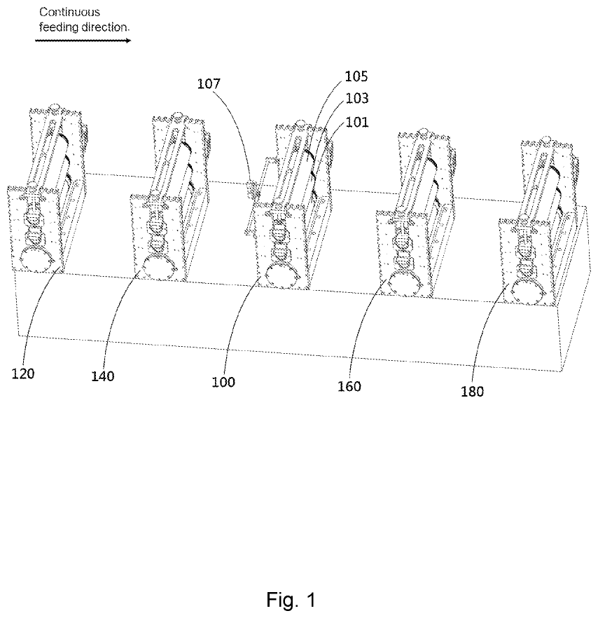

FIG. 2 is a schematic view of a movable die cutter device according to the invention.

FIG. 3A is a schematic view of a movable platform and a skid rail device according to the invention.

FIG. 3B is an exploded view of a skid rail device according to the invention.

FIG. 4 is a top view of the movable platform according to the invention.

FIG. 5 is a simplified top view of the movable die cutter device according to the invention.

### DETAILED DESCRIPTION

Reference will now be made in detail to the exemplary embodiments of the disclosure, examples of which are illustrated in the accompanying drawings. Wherever possible, the same reference numbers are used in the drawings and the description to refer to the same or like parts.

Some words are used to refer to specific elements in the whole specification and the appended claims in the disclosure. A person skilled in the art should understand that a movable die cutter device may use different names to refer to the same elements. The specification is not intended to distinguish elements that have the same functions but different names. In the following specification and claims, the terms “having”, “including”, etc. are open-ended terms, so they should be interpreted to mean “including but not limited to . . . ”.

It should be noted that in the following embodiments, features in a plurality of embodiments may be replaced, recombined, or mixed to complete other embodiments without departing from the spirit of the disclosure. The features of the embodiments may be used in any combination without departing from the spirit of the disclosure or conflicting with each other.

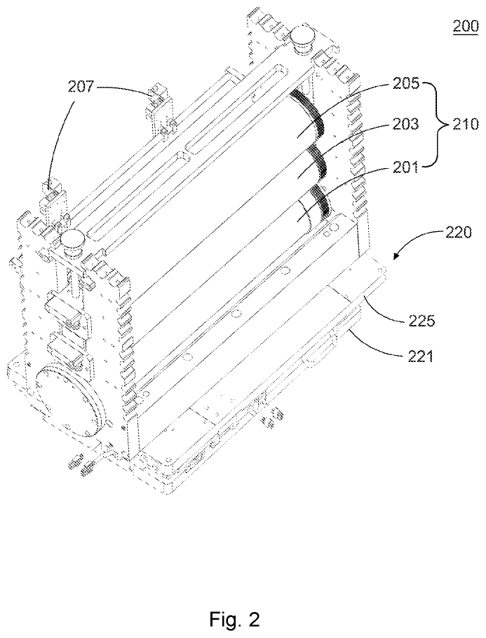

The technical content and feature of the invention is illustrated by the following embodiment and figures. Referring to FIG. 2, a movable die cutter device 200 of the invention comprises a set of die cutter 210, a skid rail unit 230 and CCD (Charge Couple Device) image sensing device 207, wherein the set of die cutter 210 includes transmission shaft 201, an anvil roll 203 and a cutter roll 205.

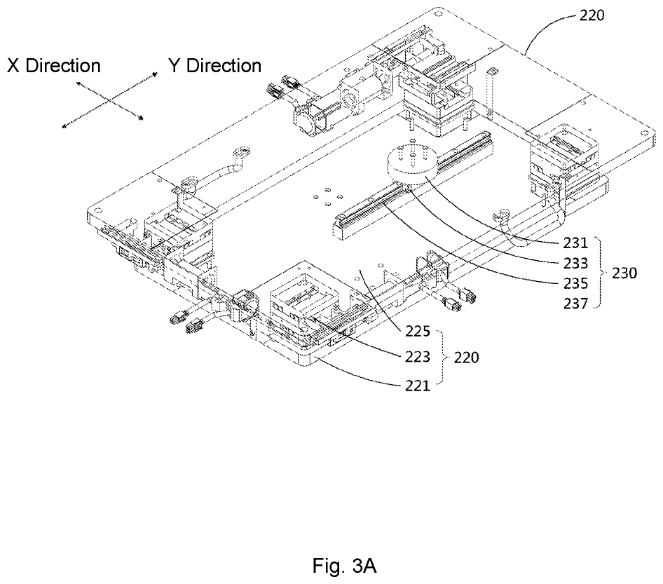

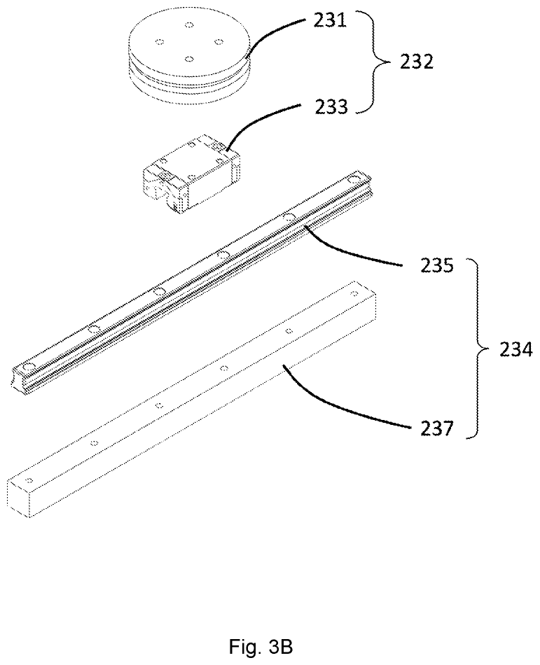

Referring to FIGS. 3A and 3B, the movable platform 220 comprises a base 221, a set of movable units 223 and an upper plate 225. The set of movable units 223 is fixed between the base 221 and the upper plate 225 and controls a movement of the upper plate 225, for example translation or rotation. The skid rail unit 230 comprises a sliding block unit 232 and a skid rail unit 234, wherein the sliding block unit 232 fixes the set of die cutter 210 and the upper plate of the movable platform 220. The skid rail unit 234 is disposed on the base 221 of the movable platform 220 and the sliding block unit 232 slides thereon. The sliding block unit 232 comprises a fixed rotation element 231 and a slide 233. The fixed rotation element 231 can fix the set of die cutter 210 on the upper plate 225 and can rotates relative to the slide 233. The skid rail unit 234 comprises skid rail 235 and skid rail seat 237 fixing the skid rail 235 on the base 221. The slide 233 can slides on the skid rail 235 in Y direction. The long axis direction (for example, the Y direction) of the skid rail unit 230 is substantially parallel to the long axis direction of the set of die cutter 210 and the set or die cutter 210 is substantially disposed on the center of the upper plate 225.

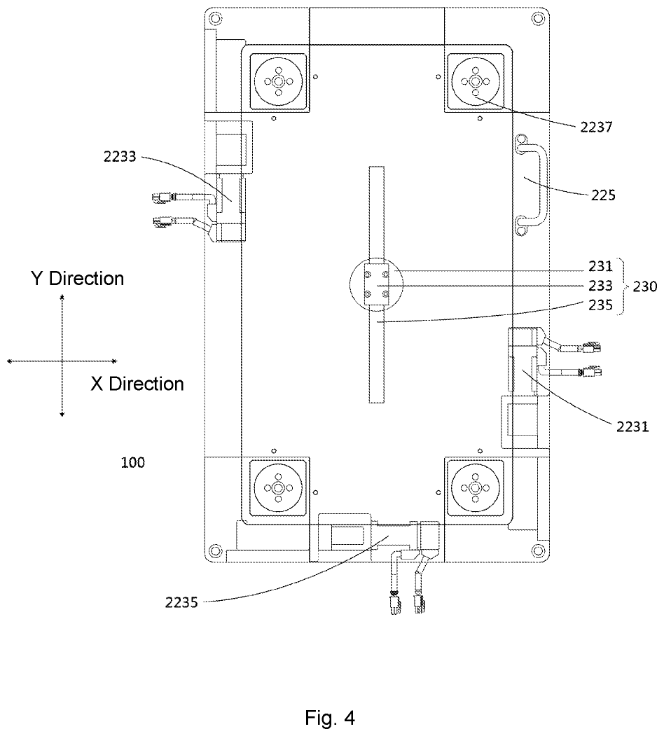

Referring to FIG. 4, an embodiment of a movable platform 220 according to the invention. A set of movable units 223 includes a first direction mobile unit 2231 moving in a first direction, a first direction mobile unit 2233 moving in a first direction, a second direction mobile unit 2235 moving in a second direction 2235 and moved unit 2237. The first direction mobile unit 2231, the first direction mobile unit 2233, the second direction mobile unit 2235 and the passive mobile unit 2237 are separately disposed on four corners of the movable platform 220. The upper plate 225 of movable platform 220 can be controlled to move horizontally by the first direction mobile unit 2231 and the first direction mobile unit 2233 in the first direction (Y direction). The first direction mobile unit 2231 and the first direction mobile unit 2233 substantially apply force in opposite directions along the first direction, and cooperate with the second direction mobile unit 2235 applies force in a second direction (X direction). Therefore, the upper plate 225 can rotates horizontally in a 9 angle relative to the first direction. The passive mobile unit 2237 can be regard as a moving reference position, so that the upper plate 225 can move in a stable horizontal direction or rotate horizontally.

The CCD (Charge Coupled device) image sensing unit 207 of the movable die cutter device 200 of the invention can be fixed on the set of die cutter 210, or can be disposed on the base 221 of the movable platform 220. Furthermore, as long as the CCD (Charge Coupled device) image sensing unit 207 can sense an offset during cutting the patterns on the continuous sheet, the location of the CCD (Charge Coupled device) image sensing unit 207 is not limited thereto. When the CCD (Charge Coupled device) image sensing unit 207 senses an offsets, the CCD (Charge Coupled device) image sensing unit 207 transmits a shift signal to a control device (not shown in the figure). The control device can control the set of the movable units 223 and make the upper plate 225 of the movable platform 220 translate or rotate horizontally to compensate the shift offset.

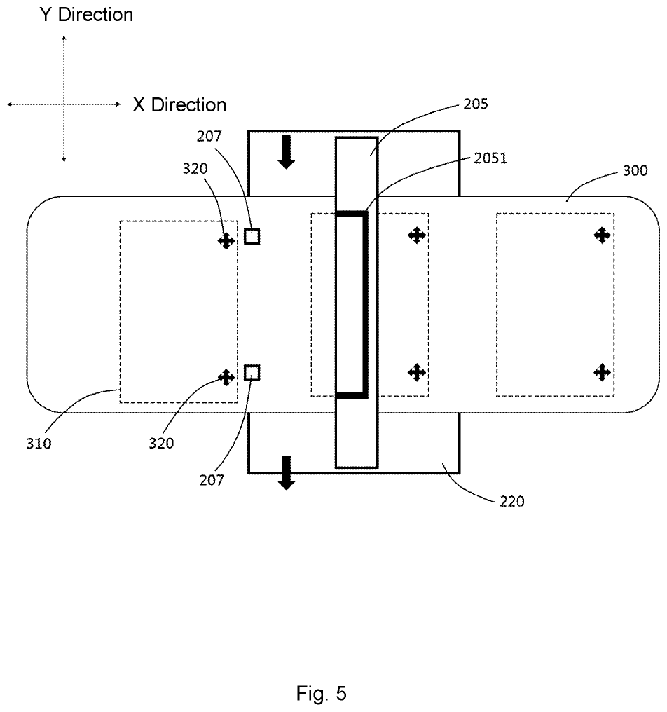

Referring to FIG. 5, when the continuous sheet 300 passes through the cutter roll 205, two CCD (Charge Coupled device) image sensing units 207 (disposed on an upstream of the cutter roll 205) separately sense two alignment marks 320 of the patterns 310. When the leftmost pattern shifts, the shift can be sensed by the CCD (Charge Coupled device) image sensing unit 207, the CCD (Charge Coupled device) image sensing unit 207 transmits a shift signal to a control device (not shown in the figure). The control device can control the set of the movable units 223 according to the deviation value, so that the movable platform 220 can move horizontally downward in the Y direction. Therefore, the patterns can be precisely cut.

Although the disclosure has been described in detail with reference to the foregoing embodiments, a person of ordinary skill in the art should understand that modifications may still be made to the technical solutions in the foregoing embodiments, or equivalent replacements may be made to part or all of the technical features; and these modifications or replacements will not cause the essence of corresponding technical solutions to depart from the scope of the technical solutions in the embodiments of the disclosure.

1. A movable die cutter device cutting patterns on a continuous sheet, comprising:
a set of die cutter cutting the continuous sheet;
a movable platform, comprising:
a base;
a set of movable units; and
an upper plate;
wherein the set of movable units is fixed between the base and the upper plate to control a movement of the upper plate;
a skid rail device, comprising;
a sliding block unit fixes the set of die cutter and the upper plate of the movable platform; and
a skid rail unit disposed on the base of the movable platform and the sliding block unit can slide on the skid rail unit;
at least one sensing device; and
a control device controlling the set of movable units;
wherein when the sensing device senses a shift between the patterns and the cutting direction of the set of die cutter, the control device controls the set of movable units of the movable platform to compensate the shift offset.

2. The movable die cutter device of claim 1, wherein the sliding block unit comprises a fixed rotation element and a slide, the fixed rotation element fixes the set of die cutter on the upper plate and rotates relative to the slide, and wherein the skid rail unit comprises a skid rail and a skid rail seat for fixing the skid rail thereon, and the slide can slide on the skid rail.

3. The movable die cutter device of claim 1, wherein the set of movable units controls the upper plate to move horizontally.

4. The movable die cutter device of claim 1, wherein a long axis direction of the skid rail unit is substantially parallel to a long axis direction of the set of die cutter.

5. The movable die cutter device of claim 4, wherein the set of movable units comprises at least one first direction mobile unit and a second direction mobile unit, and the first direction mobile unit and the second direction mobile unit separately control the upper plate to translate horizontally in a direction of the long axis of the skid rail device, or to rotate horizontally.

6. The movable die cutter device of claim 1, wherein at least one of movable units is disposed on the first corner of the movable platform, at least one of movable units is disposed on the second corner of the movable platform, and at least one of movable units is disposed on the third corner of the movable platform.

7. The movable die cutter device of claim 1, wherein the die cutter is substantially disposed on the center of the upper plate.

8. The movable die cutter device of claim 1, wherein the sensing devices are arranged on an upstream position of the continuous sheet entering the die cutter.
